(19) United States
(12) Patent Application Publication
(10) Pub. No.: US 2010/0070082 A1
(43) Pub. Date: Mar. 18, 2010

(54) METHODS AND SYSTEMS FOR CONTROLLING AN AIR CONDITIONING SYSTEM OPERATING IN FREE COOLING MODE

(75) Inventors: Julien Chessel, Villieu Loyes Mollon (FR); Pierre Delpech, Fleurieu Sur Saone (FR); Jean-Philippe Goux, Toussieu (FR)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: CARRIER CORPORATION, Farmington, CT (US)

(21) Appl. No.: 12/521,730

(22) PCT Filed: Dec. 27, 2006
(86) PCT No.: PCT/US06/49370

§ 371 Date: Jun. 29, 2009

(51) Int. Cl. G05B 15/00; F25B 1/00

(52) U.S. Cl. 700/275; 62/498

(57) ABSTRACT

A method of controlling an air conditioning system having a cooling mode and a free-cooling mode, including activating the air conditioning system; measuring a first temperature of ambient air surrounding a condenser, measuring a second temperature of the working fluid; calculating a difference between the first and second temperatures; and comparing the difference to a predetermined value, wherein if the difference is greater than or equal to the predetermined value the free-cooling mode is activated, and wherein if the difference is less than the predetermined value the cooling mode is activated.

### BACKGROUND OF THE INVENTION

1. Field of the Invention

The present disclosure is related to air conditioning systems. More particularly, the present disclosure is related to methods and systems for controlling air conditioning systems having a free-cooling mode and a cooling mode.

2. Description of Related Art

During the typical operation of air conditioning systems, the air conditioning system is run in a cooling mode wherein energy is expended by operating a compressor to compress and circulate a refrigerant to chill or condition a working fluid, such as air or other secondary loop fluid (e.g., water or glycol), in a known manner. The conditioned working fluid can then be used in a refrigerator, a freezer, a building, a car, and other spaces with climate controlled environment.

However, when the outside ambient temperature is low, there exists the possibility that the outside ambient air itself may be utilized to provide cooling to the working fluid without engaging the compressor. When the outside ambient air is used by an air conditioning system to condition the working fluid, the system is referred to as operating in a free cooling mode. As noted above, traditionally, even when the ambient outside air temperature is low, the air conditioning system is run in the cooling mode. Running in cooling mode under such conditions provides a low efficiency means of conditioning the working fluid. In contrast, running the air conditioning system under such conditions in a free cooling mode is more efficient. In the free cooling mode, one or more ventilated heat exchangers and pumps are activated so that the refrigerant circulating throughout the air conditioning system is cooled by the outside ambient air and then the cooled refrigerant is used to cool the working fluid.

Accordingly, it has been determined by the present disclosure that there is a need for methods and systems that improve the efficiency of air conditioning systems having a free cooling mode.

### BRIEF SUMMARY OF THE INVENTION

A method of controlling an air conditioning system having a cooling mode and a free-cooling mode is provided.

The method includes activating the air conditioning system; measuring a first temperature of ambient air surrounding a condenser; measuring a second temperature of a working fluid; calculating a difference between the first and second temperatures; and comparing the difference to a predetermined value, wherein if the difference is greater than or equal to the predetermined value, the free-cooling mode is activated, and wherein if the difference is less than the predetermined value the cooling mode is activated.

An air conditioning system having a cooling mode and a free cooling mode is provided.

The air conditioning system includes a condenser; a first temperature sensor for measuring a first temperature of ambient air surrounding the condenser; a working fluid; an evaporator for housing a section of the working fluid; an expansion valve being located before the evaporator; a second temperature sensor for measuring a second temperature of the working fluid; a controller for calculating a difference between the first and second temperatures, the controller comparing the difference to a predetermined value, the controller activating the free cooling mode when the difference is equal to or greater than the predetermined value, the device activating the cooling mode when the difference is less than the predetermined value; a refrigerant pump for pumping refrigerant from the condenser through an expansion valve to the evaporator when the air conditioning system is in the free cooling mode; a first valve for fluidly connecting the condenser to the expansion valve when the air conditioning system is in the cooling mode, the first valve for fluidly connecting the condenser to the refrigerant pump when the air conditioning system is in the free cooling mode; a compressor for compressing the refrigerant when the air conditioning system is in the cooling mode; and a second valve for fluidly connecting the evaporator to the condenser when the air conditioning system is in free cooling mode, the second valve for fluidly connecting the evaporator to the condenser when the air conditioning system is in the cooling mode.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is an exemplary embodiment of an air conditioning system in cooling mode according to the present disclosure.

FIG. 2 is an exemplary embodiment of an air conditioning system in free cooling mode according to the present disclosure.

FIG. 3 illustrates an exemplary embodiment of a method according to the present disclosure of operating an air conditioning system having a free-cooling mode and a cooling mode.

FIG. 4 is a graph illustrating temperature versus time for an air conditioning system utilizing only the cooling mode.

FIG. 5 is a graph illustrating temperature versus time for an air conditioning system utilizing the free cooling determination step according to the present disclosure.

### DETAILED DESCRIPTION OF THE INVENTION

The present disclosure is directed to an air conditioning system having a cooling mode and a free cooling mode. More specifically, the present disclosure is directed to methods and systems for operating an air conditioning system having a free cooling mode and a cooling mode.

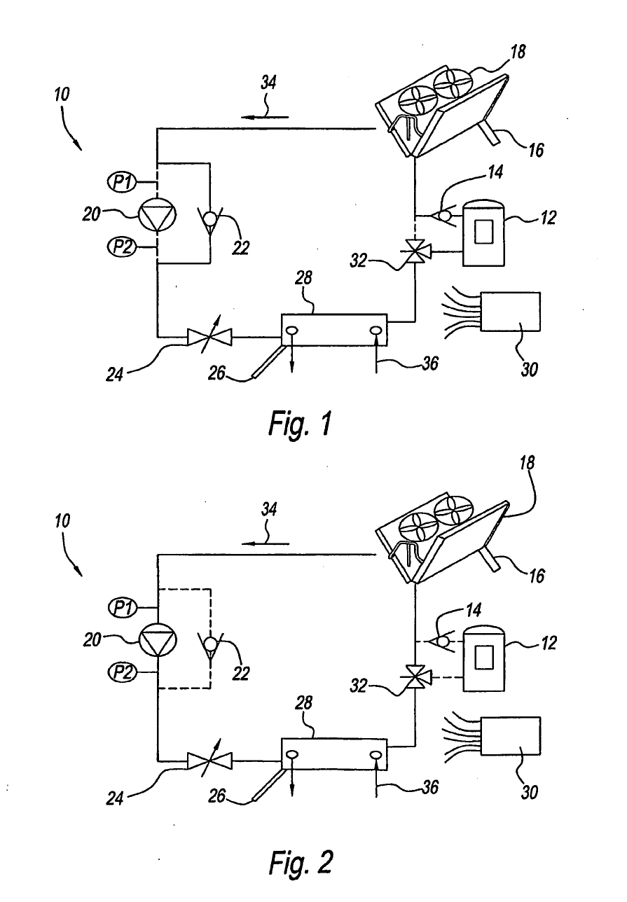

Referring to the drawings and in particular to FIGS. 1 and 2, exemplary embodiments of an air conditioning system 10 operating in cooling mode and in free cooling mode are shown and generally referred to by reference numeral 10.

Air conditioning system 10 includes a compressor 12, a first valve 14, a first temperature sensor 16, a condenser 18, a refrigerant pump 20, a second valve 22, an expansion valve 24, a second temperature sensor 26, an evaporator 28, a controller 30, a third valve 32, a refrigerant 34, and a working fluid 36.

Air conditioning system 10 in cooling mode utilizes compressor 12 to pump refrigerant 34 from evaporator 28 to condenser 18. However, air conditioning system 10 in free-cooling mode utilizes a refrigerant pump 20 to pump refrigerant throughout the system. Whereas air conditioning system 10 in cooling mode does not utilize refrigerant pump 20 during operation, air conditioning system 10 in free cooling mode does not utilize compressor 12 during operation.

Referring to FIG. 1, air conditioning system 10 operating in cooling mode operates in a known manner. Specifically, controller 30 is in electrical communication with third valve 32 so that third valve 32 is adjusted to be in position so that refrigerant 34 can flow from evaporator 28 to compressor. Controller 30 turns on compressor 12. Controller 30 turns on at least one fan in condenser 18 so that ambient air flows through the condenser. If air conditioning system 10 was operating in free cooling mode previously, controller 30 turns off refrigerant pump 20 and refrigerant 34 flows from condenser 18 through second valve 22 to expansion valve 24, thereby bypassing the refrigerant pump. Compressor 12 compresses refrigerant 34 which flows through first valve 14 to condenser 18 wherein there is a heat exchange between the refrigerant and ambient outside air and the refrigerant begins to cool. In one embodiment of the present disclosure, first valve 14 is a check valve. First temperature sensor 16 measures the temperature of the ambient outside air. Condenser 18 contains a fan that is used to bring outside ambient air into contact with refrigerant 34 so that heat from the refrigerant is transferred to the ambient air. Refrigerant 34 then passes through second valve 22, bypassing refrigerant pump 20, to expansion valve 24. In an embodiment of the present disclosure, second valve 22 is a check-valve. When expansion valve 24 is opened, compressed refrigerant 34 passes through to evaporator 28. Evaporator 28 is configured such that working fluid 36 flows through the evaporator enabling a heat exchange between refrigerant 34 and the working fluid. Second temperature sensor 26 measures the temperature of working fluid 36 exiting evaporator 28. From evaporator 28, working fluid 36 flows through third valve 32 to compressor 12. In one embodiment of the present disclosure, third valve 32 is a three-way valve. For purposes of the present disclosure, it is contemplated that working fluid 36 may be any known type suitable for allowing heat exchange between refrigerant 34 and the working fluid. For example, working fluid 36 may be either water or air.

Referring now to FIG. 2, air conditioning system 10 operating in free cooling mode is shown. When entering free cooling mode, controller 30 is in electrical communication with various elements of air conditioning system 10 placing each of them in proper configuration such that the air conditioning system can operate in free cooling mode. For example, controller 30 turns off compressor 12 and adjusts third valve 32 so that refrigerant 34 flows from evaporator 28 to condenser 18, thereby bypassing compressor 12. Additionally, controller 30 turns on at least one fan in condenser 18 so that ambient air flows through the condenser. Controller 30 also turns on refrigerant pump 20 so that refrigerant 34 flows continuously from condenser 18 to the refrigerant pump. Second valve 22 is a passive check valve. This valve allows fluid circulation from condenser 18 to expansion valve 24 and bans fluid circulation in the other way, from expansion valve 24 to condenser 18. The main functionality of second valve 22 is to prevent refrigerant 34 from flowing back to the inlet of refrigerant pump 20, when air conditioning system 10 is operating in free cooling mode. Refrigerant pump 20 pumps refrigerant 34 from condenser 18 through expansion valve 24 to evaporator 28 wherein there is a heat transfer from the refrigerant to working fluid 36 is the same manner as discussed above in the cooling mode. Second thermostat 26 measures the temperature of working fluid 36 exiting evaporator 28. Refrigerant 34 having a higher temperature than outside ambient air, then flows through third valve 32, bypassing compressor 12, to evaporator 28 as a result of natural refrigerant migration.

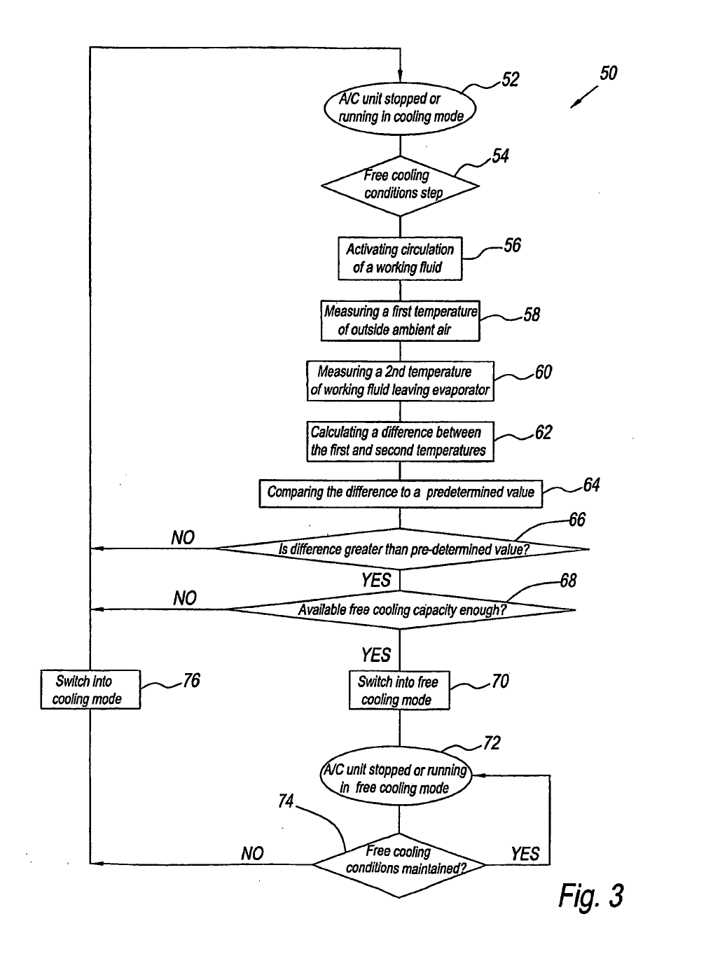

Referring to the FIG. 3, an exemplary embodiment of a method of operating an air conditioning system 10 having a cooling mode and a free cooling mode is shown and generally referred to by reference numeral 50. Method 50 includes a free cooling conditions determining step 54 a comparing difference to a pre-determined value step 66, an available free cooling capacity step 68, and a free cooling conditions check step 74.

Air conditioning unit 10 is either stopped or running in cooling mode 52. Advantageously, free cooling condition determination step 54 determines whether present conditions are sufficient to operate air conditioning system 10 in free cooling mode rather than in cooling mode, thereby optimizing the utilization of the free cooling mode.

In free cooling conditions determination step 54, the circulation of working fluid is activated 56 so that the working fluid flows in through a first opening in evaporator 28 and exits through a second opening. Next, a device is used to measure a first temperature of outside ambient air surrounding the exterior of condenser 18. In one embodiment of the present disclosure, a first thermostat 16 is used. Next, a device is utilized to measure the temperature of working fluid 36 exiting evaporator 28. In one embodiment of the present disclosure, a second thermostat 26 is utilized. It should be recognized that any device capable of measuring the temperatures of both working fluid 36 and the outside ambient air may be used. For example, it is foreseen that suitable devices may include, but not be limited to, a thermocoupling or a resistance temperature device.

A difference between the first and second temperatures is then calculated 62 by controller 30. In one embodiment of the present disclosure, controller 30 may utilize a software program to calculate the difference. The calculated difference is then compared to a pre-determined value 64 and a determination is made as to whether the difference is greater than or equal to the predetermined value or whether the difference is less than the predetermined value 66. If the difference is less than the pre-determined value, cooling mode remains on (if air conditioning system 10 was already in cooling mode) or cooling mode will be turned on if the air conditioning system was stopped. In one embodiment of the present disclosure, the pre-determined value is about six degrees Celsius. If, however, the difference is greater than or equal to the pre-determined value, there is a system check as to whether the available free cooling capacity is enough 68 to operate the system in the free cooling mode. If there is sufficient capacity, air conditioning system 10 switches into free cooling mode 70. When air conditioning system 10 switches into free cooling mode, the air conditioning system operates as shown in FIG. 2. When air conditioning system 10 is running in free cooling mode 72, the system performs a continuous check to see if free cooling conditions are maintained 74. The conditions continuously being monitored include measuring the first temperature of outside ambient air, measuring the second temperature of working fluid 36 exiting evaporator 28, calculating the difference between the first and second temperatures, and comparing the difference to a pre-determined value.

Air conditioning stem 10 will remain in free cooling mode until step 74 determines that present conditions no longer are sufficient. At such time, air conditioning system 10 switches into cooling mode 76 and operates as shown in FIG. 1.

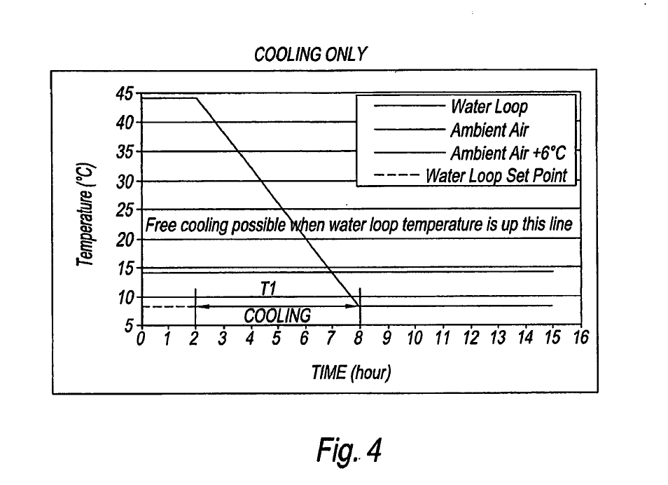

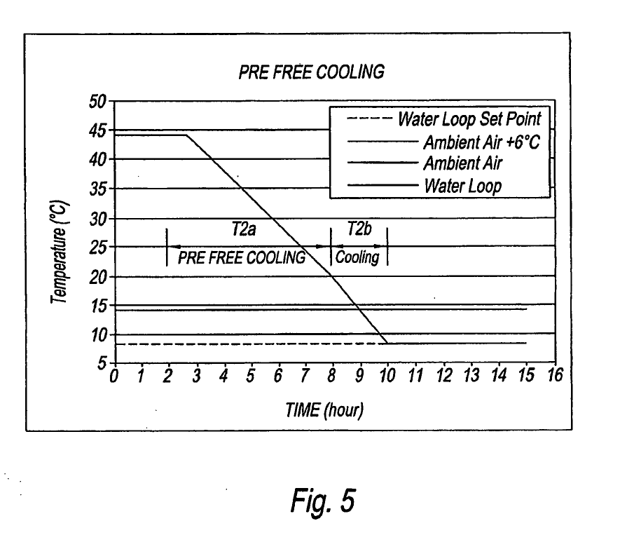

Referring now to FIGS. 4 and 5, graphs are shown wherein time in hours is plotted on the X-axis and temperature in degrees Celsius is plotted on the Y-axis. Whereas FIG. 5 illustrates an air conditioning system utilizing the pre-free cooling step according to the present disclosure, the air conditioning system of FIG. 4 does not utilize the pre-free cooling step. In both graphs, a water loop with an initial temperature of 44 degrees Celsius is brought to a final temperature of 8 degrees Celsius. In FIG. 4, the air conditioning system runs in cooling mode for six hours in order to bring the temperature of the water loop to 8 degrees Celsius. The energy required to do so is 1080 kW/hrs. In FIG. 5, however, the air conditioning system having the pre-free cooling step, operates in free-cooling mode for six hours. Subsequently, the system operates in cooling mode for two additional hours. The energy required to operate the air conditioning system of FIG. 5 is 468 kW/hrs. Advantageously, it is seen that there is an approximately 57% reduction in the energy usage associated with the cooling system equipped with the pre-free cooling step as contemplated by the present disclosure.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method of controlling an air conditioning system having a cooling mode and a free-cooling mode, comprising:
circulating a working fluid through an evaporator of the air conditioning system;
measuring a first temperature of ambient outside air;
measuring a second temperature of said working fluid exiting said evaporator;
calculating a difference between said first and second temperatures;
comparing said difference to a predetermined value;
operating the air conditioning system in the free-cooling mode if said difference is greater than or equal to said predetermined value; and
operating the air conditioning system in the cooling mode if said difference is less than said predetermined value.

2. The method of claim 1, wherein said first temperature of ambient outside air is measured proximate to a condenser of the air conditioning system.

3. The method of claim 1, wherein measuring said first temperature comprises controlling a first temperature sensor to determine said first temperature and measuring said second temperature comprises controlling a second temperature sensor to determine said second temperature.

4. The method of claim 1, wherein said calculating step is performed by a software program.

5. The method of claim 1, wherein said predetermined value is about six degrees celsius.

6. The method of claim 1, wherein said comparing step is performed during operation of the air conditioning system in the cooling mode.

7. The method of claim 1, wherein said comparing step is performed when the air conditioning system is not operating in either the cooling or free cooling modes.

8. An air conditioning system having a free cooling mode and a cooling mode, comprising:
a condenser;
a first temperature sensor for measuring a first temperature of ambient outside air;
an evaporator in separate fluid communication with a working fluid and a refrigerant;
an expansion valve being located before said evaporator;
a second temperature sensor for measuring a second temperature of the working fluid as the working fluid exits said evaporator;
a refrigerant pump for pumping refrigerant from said condenser through an expansion valve to said evaporator when the air conditioning system is in the free cooling mode;
a second valve for fluidly connecting said condenser to said expansion valve when the air conditioning system is in the cooling mode, said second valve for fluidly connecting said condenser to said refrigerant pump when the air conditioning system is in the free cooling mode;
a compressor for compressing the refrigerant when the air conditioning system is in the cooling mode;
a third valve for fluidly connecting said evaporator to said condenser when the air conditioning system is in the free cooling mode, said third valve for fluidly connecting said evaporator to said condenser when the air conditioning system is in the cooling mode; and
a controller for calculating a difference between said first and second temperatures, said device comparing said difference to a predetermined value, said controller adjusting positions of said first and second valves, turning on said compressor, and turning off said refrigerant pump when said difference is equal to or greater than said predetermined value, said controller turning off said compressor, turning on said refrigerant pump, and adjusting positions of said second and third valves when said difference is less than said predetermined value.

9. The air conditioning system of claim 8, wherein said third valve is a three way valve.

10. The air conditioning system of claim 8, wherein said second valve is a check-valve.

11. The air conditioning system of claim 8, wherein said working fluid is water.

12. The air conditioning system of claim 5, wherein said working fluid is air.
